(19) United States
(12) Patent Application Publication
(10) Pub. No.: US 2008/0095052 A1
(43) Pub. Date: Apr. 24, 2008

(54) Network Control Time Spans

(76) Inventors: Patrick Julien, Mascouche (CA); Bryan Mongeau, Montreal (CA); Daniel Parisien, Montreal (CA)

Correspondence Address: TECHNOLOGY LAW GROUP, LLC, 2215 West State Street, BOISE, ID, 83702, US

(21) Appl. No.: 11/828,225

(22) Filed: Jul. 25, 2007

Related U.S. Application Data
(60) Provisional application No. 60/820,589, filed on Jul. 27, 2006.
(60) Provisional application No. 60/820,591, filed on Jul. 27, 2006.
(60) Provisional application No. 60/820,594, filed on Jul. 27, 2006.
(60) Provisional application No. 60/820,595, filed on Jul. 27, 2006.
(60) Provisional application No. 60/820,598, filed on Jul. 27, 2006.

(51) Int. Cl. G08C 15/06

(52) U.S. Cl. 370/230

(57) ABSTRACT

A system and method for efficiently utilizing network bandwidth in a network having multiple components that need to transfer a number of different datasets. The invention provides that distinct data transfer service agents be deployed to manage different kinds of data, and that each service has a separate network control schedule that can be independently controlled from the other services, resulting in a an easily configurable system where large content transfers can easily be restricted to non peak hours and smaller control and reporting data transfers can still be permitted during some or all peak times. In a digital signage network, this invention allows large data transfers of advertising content to be restricted to non peak hours, but advertising control and reporting can occur more frequently, and can easily be specified and modified to maximize efficiency of network resources. The invention further recognizes that common schedule arrangements are either to allow data transfers at all times or to restrict transfers to a particular time, and teaches a scheme, where if a whitelist of times is present, it restricts data transfers to listed times, but if the whitelist is not present for an entire day, data transfer are allowed rather than disallowed for that day.

### CROSS-REFERENCE TO RELATED APPLICATIONS

This applications claims priority under 35 U.S.C. §119(e) to U.S. Provisional Application No. 60/820,589, filed Jul. 27, 2006, entitled “Network Control Time Spans,” U.S. Provisional Application No. 60/820,591, filed Jul. 27, 2006, entitled “Broadcast Day,” U.S. Provisional Application No. 60/820,594, filed Jul. 27, 2006, entitled “Campaign Performance Report,” U.S. Provisional Application No. 60/820,595, filed Jul. 27, 2006, entitled “Day Part Frame Criteria,” and U.S. Provisional Application No. 60/820,598, filed Jul. 27, 2006, entitled “Fine-Grained Criteria Targeting,” the entire contents of each are hereby incorporated by reference.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISC APPENDIX

Not applicable.

### BACKGROUND OF THE INVENTION

This invention relates to enhancements to a digital signage system. More particularly, the invention relates to a system and method for managing and restricting time periods for various kinds of digital signage related network traffic.

Consumer product advertising is rapidly migrating from traditional media, such as billboards, newspapers, magazines, mailings, television and radio, to a medium of networks of digital signs. A digital sign network typically includes a number of display units, where each display unit typically is divided into multiple frames, and each frame is able to display an advertising message. The digital paradigm is vastly superior to traditional signage systems because content can be changed instantly and inexpensively, allowing a single display unit to service multiple advertisers. This is often a “win-win” situation for both consumers and advertisers. Consumers generally find changing content more interesting. The digital paradigm benefits advertisers who can “time share” valuable advertising space and venues with other advertisers, giving them more affordable access to formally cost prohibitive advertising platforms.

In a digital signage system, where remote component interface to each other with a wide area network, such as the internet, it is generally desirable to restrict to off peak areas the transmission of large blocks of content. For instance, in a department store that is open from 9:00 AM to 5:00 PM the network traffic may need to be conserved during operating hours for the store's business purposes, so that sufficient bandwidth is available to transfer sales and billing information, and it is desirable to postpone large transfers of advertising data to evening hours when the retail operation is closed. What is need is a system and a method to efficiently manage network traffic for a diverse set of components connected by a wide area network.

### BRIEF SUMMARY OF THE INVENTION

The present invention uniquely solves the problems addressed above over the prior art. The present invention provides for a system and method to manage network traffic in a digital signage system. Specifically, the present invention provides for the deployment of a network control schedule interfaced with a plurality of network data transfer services. Each network data transfer service can be independently configured to either disregard or honor the network control schedule. The present invention recognizes the necessity of, and provides for, properly interfacing the network control schedule with the system status and reporting features so that the system can correctly distinguish between network failures and voluntary suspension of network traffic. One embodiment of the invention provides for a network control schedule having a whitelist. The whitelist contains a list of all times network uploads and downloads are allowed. In this embodiment, if the whitelist contains no times for a particular day, then network download and uploads are allowed throughout the day.

The present invention can be used in conjunction with one or more network transfer services. Appropriate network transfer services include, but are not limited to, a content download manager, which manages downloads and uploads between components of a network, a report data exchange manager for managing report related data exchanges between network components, a control data exchange manage for managing control related data exchanges between network components, and a data feed synchronizer for managing and synchronizing streams of data from external sources to network components.

The invention provides that multiple network data transfer services can be simultaneously supported, each having its own network control schedule, allowing each service to be configured independently from other services. Each service can be configured to either disregard the network control schedule, in which case data transfers can occur at any time, or to honor the network control schedule, limited data transfers to the times allowed by the whitelist.

The invention further provides for a component status monitor that is aware of the appropriate network control schedule, and thus can distinguish a failed component from one that is voluntarily refraining from responding to a status request because of compliance to a network control schedule.

For convenience, one embodiment of the present invention provides that for a given day, if a whitelist contains no allowable times, downloads are allowed all days rather than disallowed all day.

The invention is particularly well suited for a network of digital media servers, each capable of interface with various network data transfer services, and able to receive large streams of advertising content as well as transfer smaller streams of control and report data. By allowing independent control of the various transfer services, bandwidth intensive transfers can be disallowed during peak network traffic time, but smaller control and data streams can be allowed even when large content transfers are not.

### BRIEF DESCRIPTION OF THE SEVERAL VIEWS OF THE DRAWING

FIG. 1 describes generally a block diagram of one embodiment of the present invention.

### DETAILED DESCRIPTION OF THE INVENTION

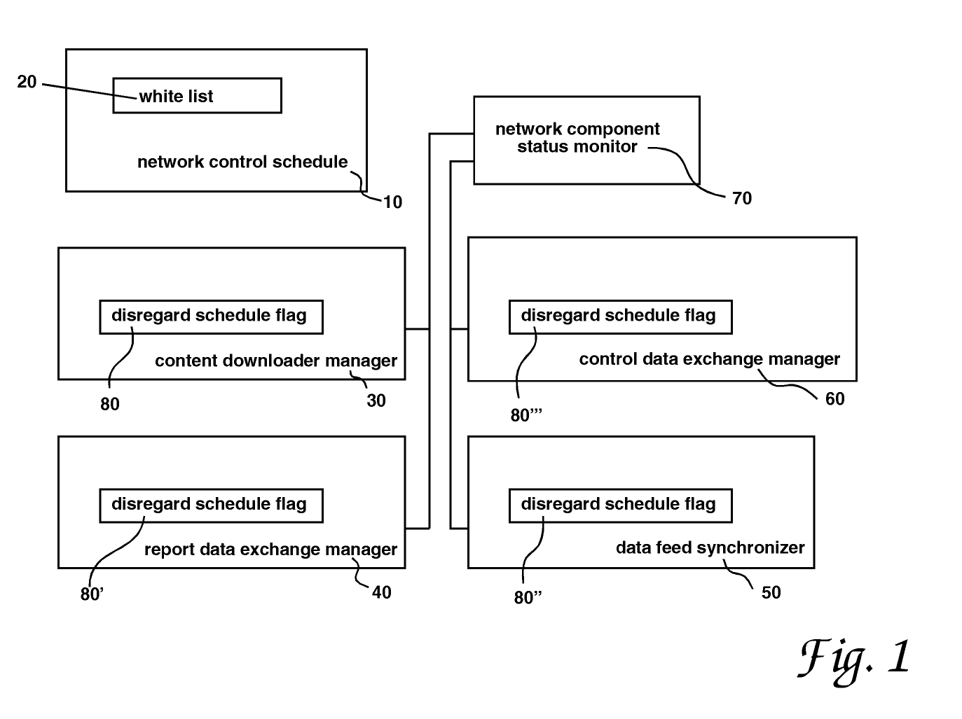

FIG. 1 depicts generally the main components of the present invention as a block diagram. Referring to FIG. 1, which depicts one embodiment, a network control schedule 10 having a whitelist 20 is depicted. The network control schedule 10 is made available to all available network data transfer services, which, in FIG. 1, includes a content downloader manager 30, a report data exchange manager 40, a data feed synchronizer 50, and a control data exchange manager 60.

Each network data transfer service includes a configurable “disregard schedule flag” 80, that, when invoked, will allow the containing network transfer service to upload and download data at any time regardless of the schedule. This is allowed because for a particular environment, the data for a particular data transfer services may be small enough that the required bandwidth is insignificant. For example, control data, as managed by the control data manager 60 is typically much small than the content data managed by the content downloader manager, and so the system can be easily configured to allow control data at all times but restrict content downloads to network control schedule 10.

One benefit of this particular design is that it is rarely relatively easy to specify a workable network schedule delaying large data transfers to non-peak hours and yet allow for exceptions when necessary, but allowing components to be dynamically configured to disregard the schedule either because that data associated for that service is small, or because of some extraordinary circumstance. Furthermore, in practice rarely is an unworkable or ineffective schedule specified because the whitelist contains times generally known to be appropriate for large data transfers, and the ability to individually configure components eliminates the need to modify the schedule for occasional exceptional situations.

FIG. 1 also depicts a network component status monitor responsible for monitoring the health of various components on the network and determining when components become unavailable due to some kind of failure. Under this system, the network status monitor takes into account the network control schedule to eliminating false failure reports for components that are inactive because they are scheduled to be inactive rather than because they have experienced a failure.

In a digital signage system, the network components would typically include media servers that deliver immediate content to electronic signs, and remote centralized servers that both manage and store large amounts of content data, and also provide for system wide management of a large network of electronic digital signs. Some locations may have localized edge servers that server as local repositories for large data sets, this design allows edge servers to synchronize with centralized servers during off-peak hours so that they will have local caches of current advertising content, that can be delivered more efficiently to localized media servers without requiring large data transfers during busy or expensive network times.

This description is provided for the purposes of illustration, not limitation. As one skilled in the art will appreciate, there are a number of alternate embodiments of the present invention not shown, that are in the spirit of the invention. The invention is only limited by the claims as set forth below.

We claim:

1. A system for efficiently utilizing network bandwidth in a wide area networking environment comprising:
a network control schedule, the network control schedule further includes a whitelist, the whitelist further includes a plurality of times wherein network downloads are allowed,
a plurality of network data transfer services, wherein each network data transfer service can be independently configured to either disregard the network control schedule and perform downloads at any time, or honor the network control schedule and download only during times specified by the whitelist.
a network component status monitor, wherein a status indicating voluntary inactivity is reported when status is sought for a service during a time period when the service has voluntarily suspended data transfers in compliance with said network control schedule.

2. The system of claim 1, wherein, if, for a given day, said whitelist contains no times for said given day, downloads for said given day are allowed the entire said given day.

3. The system of claim 2, wherein one of the network data transfer services is one of the following services: a content download manager, a report data exchange manager, a control data exchange manager, a data feed synchronizer.

4. A system for efficiently utilizing network bandwidth in a wide area networking environment comprising:
a network control schedule, the network control schedule further includes a whitelist, the whitelist further includes a plurality of times wherein network downloads are allowed,
a digital signage system having a plurality of digital media servers, each server capable of storing signage data,
a plurality of network data transfer services, wherein each network data transfer service can be independently configured to either disregard the network control schedule and perform data transfers at any time, or honor the network control schedule and perform data transfers only during times specified by the whitelist.
wherein downloads and uploads between a first digital media server and a second digital media server on the wide area network are managed by at least one network data transfer service.

5. The system of claim 4, wherein, if, for a given day, said whitelist contains no times for said given day, downloads for said given day are allowed the entire said given day.

6. The system of claim 5, wherein one of the network data transfer services is one of the following services: a content download manager, a report data exchange manager, a control data exchange manager, a data feed synchronizer.

7. A method for efficiently utilizing network bandwidth in a wide area networking environment comprising the steps of:
associating a network control schedule with the wide area networking environment, the network control schedule further includes a whitelist, the whitelist further includes a plurality of times wherein network downloads are allowed,
associating a plurality of network data transfer services, wherein each network data transfer service can be independently configured to either disregard the network control schedule and perform downloads at any time, or honor the network control schedule and download only during times specified by the whitelist with the wide area networking environment.
associating a network component status monitor, wherein a status indicating voluntary inactivity is reported when status is sought for a service during a time period when the service has voluntarily suspended data transfers in compliance with said network control schedule with the wide area networking environment.

8. The method of claim 7, wherein, if, for a given day, said whitelist contains no times for said given day, downloads for said given day are allowed the entire said given day.

9. The method of claim 8, wherein one of the network data transfer services is one of the following services: a content download manager, a report data exchange manager, a control data exchange manager, a data feed synchronizer.

10. A method for efficiently utilizing network bandwidth in a wide area networking environment comprising the steps of:
associating a network control schedule with the wide area networking environment, the network control schedule further includes a whitelist, the whitelist further includes a plurality of times wherein network downloads are allowed,
associating a digital signage system having a plurality of digital media servers, each server capable of storing signage data with the wide area networking environment,
associating a plurality of network data transfer services, wherein each network data transfer service can be independently configured to either disregard the network control schedule and perform data transfers at any time, or honor the network control schedule and perform data transfers only during times specified by the whitelist with the wide area networking environment.
wherein downloads and uploads between a first digital media server and a second digital media server on the wide area network are managed by at least one network data transfer service.

11. The method of claim 10, wherein, if, for a given day, said whitelist contains no times for said given day, downloads for said given day are allowed the entire said given day.

12. The method of claim 11, wherein one of the network data transfer services is one of the following services: a content download manager, a report data exchange manager, a control data exchange manager, a data feed synchronizer.
